(19) United States
(12) Patent Application Publication
(10) Pub. No.: US 2006/0264116 A1
(43) Pub. Date: Nov. 23, 2006

(54) Jack connector

(75) Inventors: Yung-Chien Chung, Tu-Cheng (TW); Kun-Hua Chen, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/438,662

(22) Filed: May 22, 2006

(30) Foreign Application Priority Data
May 20, 2005 (CN) 200510040126.2

(51) Int. Cl. H01R 24/04

(52) U.S. Cl. 439/668

(57) ABSTRACT

A jack connector (100) for electrically connecting a mating plug and a PCB comprises an insulative housing (10), a first contact (20) and a second contact (30) both accommodated in the insulative housing (10). The housing (10) defines a plug-insertion hole (110) and a side wall (13) having a depression (132) therein. The first contact (20) contains a cylindrical-shaped pin (23) extending within said plug-insertion hole (110) and a tab (221) projecting toward said pin wherein the tab is slantedly retained in the depression (132). Under this condition, the first contact can be retained in the insulative housing with strong retention force for preventing a front-to-back movement of the first contact (20).

### BACKGROUND OF THE INVENTION

1. Field of the Invention

This invention generally relates to a jack connector, and more particularly to a power jack connector with a contact to be retained in the housing.

2. Description of the Prior Art

Chinese Utility Patent No. ZL03256509.7 discloses a conventional jack connector. According to the patent, the conventional jack connector includes an insulative housing, a first contact and a second contact both accommodated in the insulative housing. The insulative housing further defines a mating wall, a mounting wall opposite the mating wall and a plug-insertion hole extending from the mating wall wherein the mounting hole contains a U-shaped hole in communication with the plug-insertion hole. The first contact contains a connecting portion and a cylindrical-shaped pin extending from the connecting portion and within the plug-insertion hole. The cylindrical-shaped pin and the connecting portion each define a barb for engaging with the inner side of the U-shaped hole for retention purpose. However, after repeated insertions of the mating plug into the plug-insertion hole, the first contact subjects to an undesired movement because the retaining force exerted by the barbs is not big enough.

Hence, it is desired to have a jack connector with an improved contact which can be retained in the insulative housing firmly therefore solving the problem above.

### BRIEF SUMMARY OF THE INVENTION

Accordingly, an object of the present invention is to provide a jack connector with a contact to be steadily retained in the insulative housing.

In order to attain the objective above, a jack connector for electrically connecting a mating plug and a PCB comprises an insulative housing, a first contact and a second contact both accommodated in the insulative housing. The housing defines a plug-insertion hole and a side wall having a depression therein. The first contact contains a cylindrical-shaped pin extending within said plug-insertion hole and a tab projecting toward said pin wherein the tab is slantedly retained in the depression. Under this condition, the first contact can be retained in the insulative housing with strong retention force for preventing a front-to-back movement of the first contact.

Other objects, advantages and novel features of the invention will become more apparent from the following detailed description of the present embodiment when taken in conjunction with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a perspective view of a jack connector according to the present invention;

FIG. 2 is an exploded view of the jack connector;

FIG. 3 is a part assembled view of the jack connector;

FIG. 4 is another perspective view of the jack connector; and

FIG. 5 is a cross section view of the jack connector taken from 5-5 line of FIG. 4;

### DETAILED DESCRIPTION OF THE INVENTION

Reference will now be made in detail to the preferred embodiment of the present invention.

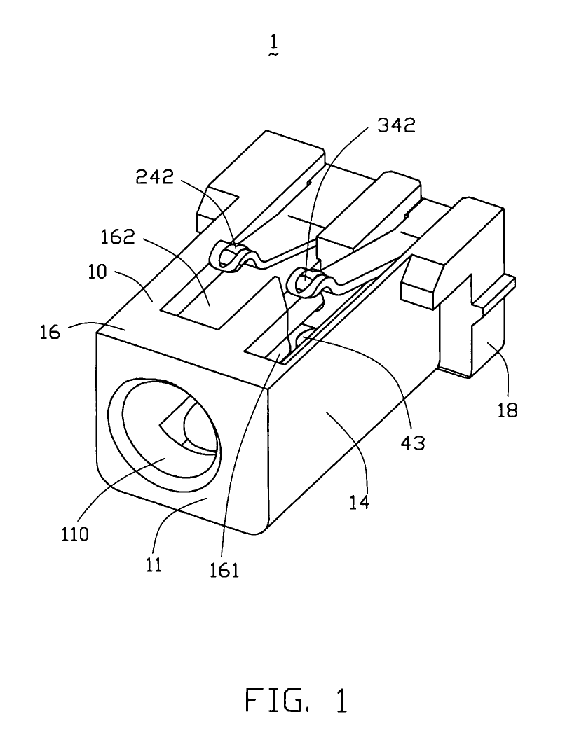

Refer to the drawings and in particular to FIGS. 1-3, a jack connector 1 in accordance with the present invention for electrically connecting a complementary mating plug (not shown) and a printed circuit board (PCB) comprises a rectangular-shaped insulative housing 10, a first contact 20, a second contact 30 and a retaining contact 40 all accommodated in the insulative housing 10.

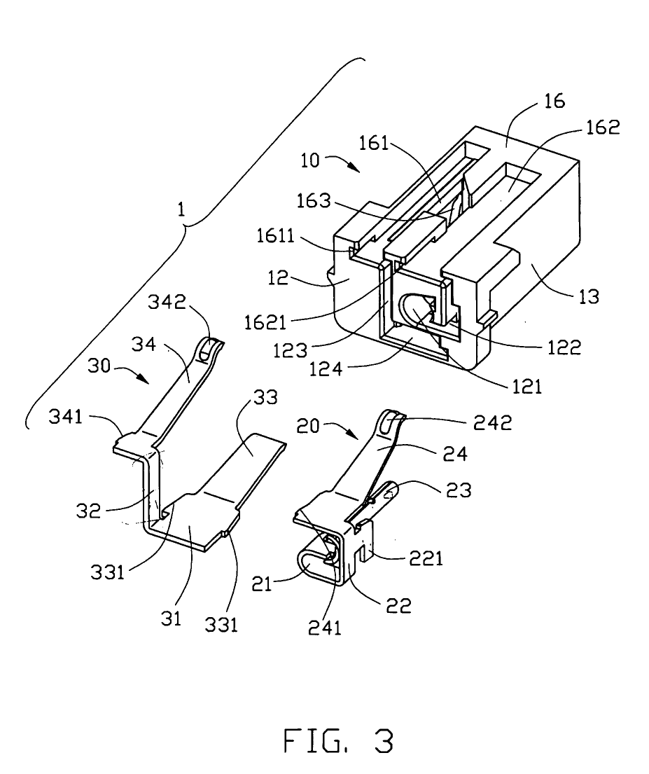

The insulative housing 10 comprises a mating wall 11, a mounting wall 12 opposite the mating wall 11, a pair of side walls 13, 14 extending rearward from opposite sides of the mating wall 11, a top wall 16 and a bottom wall 15 respectively ranging rearward from top and bottom edges of the mating wall 11 and perpendicularly to the side walls 13, 14, a pair of flanges 17, 18 extending outward from the side walls 13, 14 near the mounting wall 12 and a plug-insertion hole 110 extending inwardly from the mating wall 11 for receiving the mating plug therein. Besides, there sets a U-shaped receiving hole 121 through the mounting wall 12 communicating with the plug-insertion hole 110. At both sides of the receiving hole 121, there further forms a first slit 122 in communication with the receiving hole 121, a second slit 123 opposite the first slit 122 and a third slit 124 which communicates with the second slit 123 and sets below the receiving hole 121. All of the slits 122, 123, 124 extend a predetermined distance from the mounting wall 12 into the housing 1. The top wall 16 defines a pair of first and second slots 162, 161 nearly parallel to each other and a connecting slot 163 therebetween (see FIG. 3) wherein each slot 161, 162 further includes a recess 1611, 1621 extending to the side walls 13, 14 from the rear bottom plate of each slot 161, 162. The bottom wall 15 defines a groove 151 in communication with the slot 161 for receiving the contact 40 therein. The side wall 13 defines a cutout 131 adjacent to the flange 17 wherein the cutout 131 further defines a rectangle-shaped depression 132 inward in communicating with the plug-insertion hole 110. The second slot 161 and the slits 123, 124 communicate together for accommodating the second contact 30. Besides, the first slot 162 together with the first slit 122 and the hole 121 is adapted for receiving the first contact 20 therein.

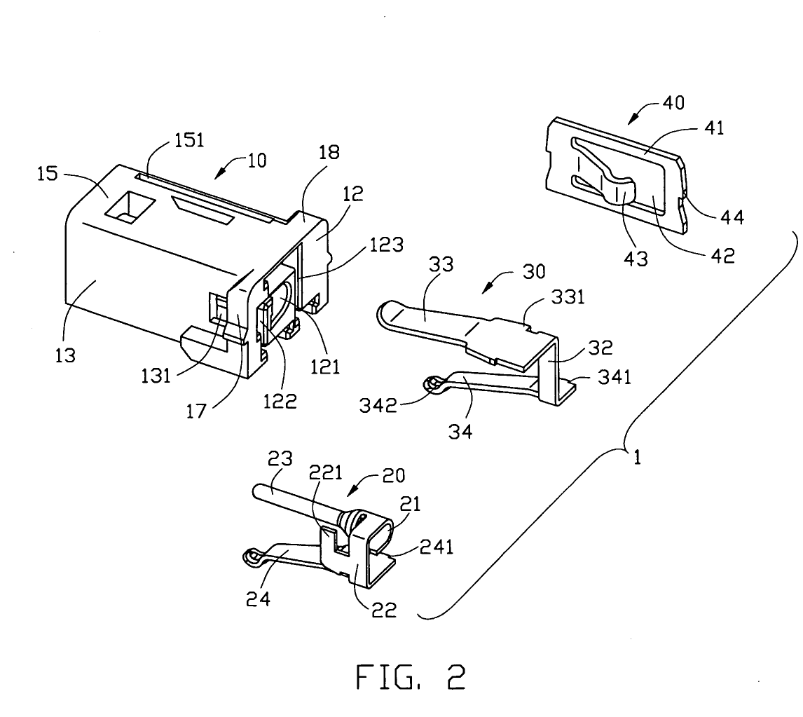

Referring to FIGS. 2 and 3, the first contact 20 contains a connecting portion 22 defining a rectangle-shaped tab 221 disposed in a free end thereof, a first resilient tab 24 extending from the one upper edge of the connecting portion 22 and a U-shaped fixing portion 21 extending from the other lower edge of the connecting portion 22. The first resilient tab 24 further contains a barb 241 in the back for engaging with the recess 1621 and a contact portion 242 in the front for connecting to a PCB. Said fixing portion 21 further contains a cylindrical-shaped pin 23 extending forward from the fixing portion 21 (see FIG. 3) and parallel to the connecting portion 22. The contact 30 contains a intermediate portion 32 disposed in the second slit 123 of the housing 1, a second resilient tab 34 extending from the upper edge of the intermediate portion 32 and a finger 33 extending from the lower edge of the intermediate portion 32. Said second resilient tab 34 extends along a direction parallel to the finger and further contains a barb 341 in the back for engaging with the recess 1611 and a contact portion 342 in the front for connecting to the PCB. The finger 33 contains a free end (not labeled) extending into the plug-insertion hole 110 for mating with the mating plug for grounding purpose and a fixing portion 31 opposite the free end with a pair of barbs 331 for engaging with the third slit 124.

Referring to FIG. 2, the retaining contact 40 includes a planar base 41 with a through hole 42 defined therein, and a resilient finger 43 extending rearward and sideward from a forward end of the base 41 for resiliently abutting against the complementary plug. A plurality of barbs 44 are formed on lateral sides of the base 41 for securing the retaining contact 40 in the groove 151.

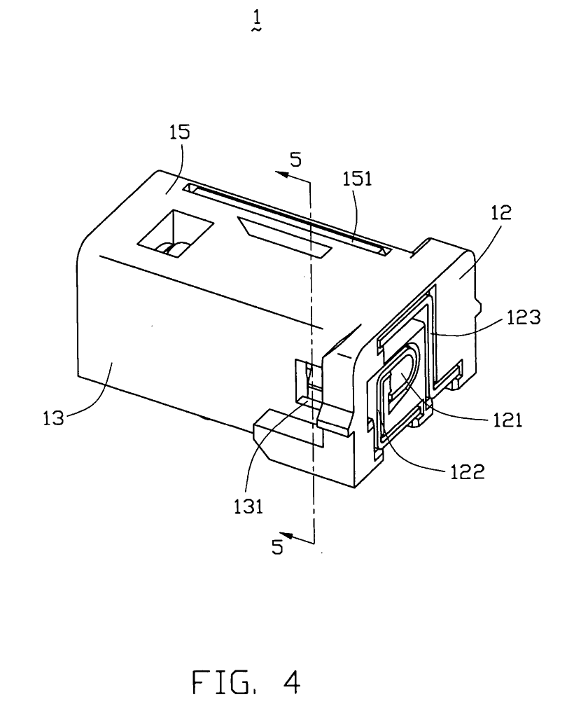

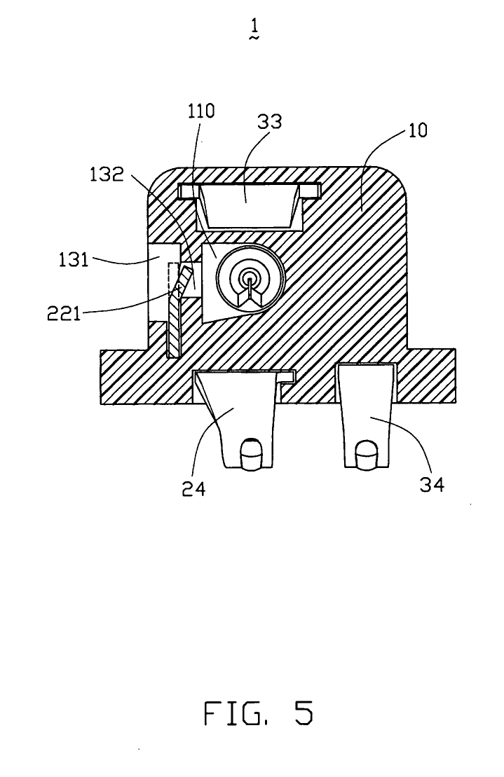

Refering to FIGS. 1-5, in assembly, first, insert retaining contact 40 into the corresponding groove 151 from the slot 161 of top wall 16 of the insulative housing 10 wherein the resilient finger 43 is inserted downward along the connecting slot 163 then extends into the plug-insertion hole 110 for engaging with the mating plug and the barbs 44 of the base 41 are interferentially engaging with the groove 151 for preventing an upper-and-lower movement of the contact 40. Then, insert the first and the second contacts 20, 30 from the mounting wall 12 of housing 10 to get a semi finished product wherein the second contact 30 is positioned adjacent to said first contact 20 and extending approximately parallel to the first contact 20. Said first and the second tabs 24, 34 are accommodated in the slot 161, 162 and the contact portion 242, 342 are extending beyond of the top wall 16 for contacting the PCB. The barbs 241, 341 are engaging with corresponding recess 1611, 1711. The fixing portion 31 of the finger 33 is retained in the third slit 124 wherein the barb 331 abuts against the inner side of the third slit 124. The U-shaped fixing portion 21 is received in the corresponding U-shaped receiving hole 121 wherein both of the finger 33 and the cylindrical-shaped pin 23 are extending into the hole 110 for engaging with the mating plug respectively from the third slit 124 and the receiving hole 121. Besides, the connecting portion 22 and the intermediate portion 32 are respectively inserted into the first slit 122 and the second slit 123 wherein the rectangle end 27 emerges in the cutout 131 outside the depression 132. Under this condition, the contact 20 may be loose because the retention force between the contact 20 and the housing 10 is not big enough.

Finally, stamping the tab 221 wedged into the depression 132 of the housing 10 inwardly from the cutout 131 to thereby obtaining finished products. The tab 221 is slantedly retained in the depression 132 so as to fix the first contact 20 retained tightly in the housing 10 for purpose of preventing a front-to-back movement of the first contact 20.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

What is claimed is:

1. A jack connector for electrically connecting a mating plug and a printed circuit board (PCB), comprising:
an insulative housing having a mating wall, a plug-insertion hole extending from the mating wall, and a side wall defining a depression therein;
a first contact accommodated in the insulative housing and having a cylindrical-shaped pin extending within said plug-insertion hole, the first contact including a connecting portion extending parallel to said pin with a tab projecting toward said pin and retained in the depression for preventing a front-to-back movement of the first contact; and
a second contact positioned adjacent to said first contact and extending parallel to the first contact.

2. The jack connector according to claim 1, wherein the tab is formed in a free end of the connecting portion and stamped to be slantedly retained in the depression after said first contact is inserted into the insulative housing.

3. The jack connector according to claim 1, wherein the side wall defines a cutout exposed to an outside thereof and communicating with the depression.

4. The jack connector according to claim 1, wherein the insulative housing defines a mounting wall opposite to the mating wall, and the mounting wall defines a plurality of slits therethrough.

5. The jack connector according to claim 4, wherein a U-shaped receiving hole is defined through said mounting wall between said slits and communicates with the plug-insertion hole.

6. The jack connector according to claim 5, wherein the first contact comprises a U-shaped fixing portion extending from a rear end of the cylindrical-shaped pin and received in the U-shaped receiving hole.

7. The jack connector according to claim 6, wherein the first contact defines a first resilient tab extending from one edge of the connecting portion and the U-shaped fixing portion is extending from the other edge of the connecting portion.

8. The jack connector according to claim 7, wherein the first resilient tab forms a barb thereon for engaging within the insulative housing and a contact portion for connecting to the PCB.

9. The jack connector according to claim 1, wherein the second contact comprises an intermediate portion, a second resilient tab extending from an upper edge of the intermediate portion, and a finger extending from a lower edge of the intermediate portion.

10. The jack connector according to claim 9, wherein the second resilient tab extends along a direction parallel to the finger.

11. The jack connector according to claim 9, wherein the finger defines a free end adapted to be inserted in the plug-insertion hole and a fixing portion for retaining the second contact in the insulative housing.

12. The jack connector according to claim 1, further comprising a retaining contact accommodated in the insulative housing, the retaining contact including a planar base and a resilient finger which is extending from the base and into the plug-insertion hole for abutting against the inserted mating plug.

13. The jack connector according to claim 1, wherein said jack connector is a power jack connector.
